(19) United States
(12) Patent Application Publication
(10) Pub. No.: US 2008/0155460 A1
(43) Pub. Date: Jun. 26, 2008

(54) SYSTEM AND METHOD FOR PANNING CONTENT

(76) Inventors: Sherryl Lee Lorraine Scott, Toronto (CA); Gerhard Dietrich Klassen, Waterloo (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, omitted

(21) Appl. No.: 11/615,210

(22) Filed: Dec. 22, 2006

(51) Int. Cl. G06F 3/048

(52) U.S. Cl. 715/784

(57) ABSTRACT

Panning the display of content on a computing device, particularly a handheld device, can be awkward using incorporated track wheels or track balls especially when walking and operating the device. A graphical user interface that provides panning operations through key-based inputs and that teaches a user how to pan using the keys provides a solution.

### FIELD

The present application relates to viewing content in a graphical user interface (GUI) of a computing device, for example, a handheld wireless communication device.

### BACKGROUND

People on the go rely on handheld communication devices such as wireless mobile devices, cellular phones and PDAs, among others. These devices are useful to keep in contact with other people, organize personal schedules and to view information. For example, such devices often include GUIs for viewing content such as images (maps, pictures, etc.), text documents, and combinations thereof.

A software-based application on the device, such as a map viewer/navigation application, may provide a GUI to retrieve and display images representing a map for geographic areas. Often, it is necessary to pan about the image (or images) defining the map to see the desired information. A user may want to zoom in or out to see more or less detail. Due to the smaller size of display screens of handheld devices and the appropriate resolution required to display the map, a user may need to pan in various directions to have the desired information displayed on the screen.

It is thus helpful to present a GUI that enables panning and that is simple to operate and easy to learn. Often a user assumes that a GUI for one application or feature on a device will adopt common and previously learned techniques for operating other GUIs or features of the device. For example, many such devices include a track wheel or track ball input device as a primary input device for moving a focus to navigate about the display screen. This input device is commonly used by different applications.

Walking and using the handheld device, particularly with two hands, to operate a track wheel or track ball input device can be difficult. Movement of the user, especially when walking and using the handheld device, may translate through the user to his or her hands such that fine control of a track wheel or tack ball may not be as effective as when a user is not moving during operation of these input devices. When operating these types of input devices, unintentional inputs to the GUI may be occasioned which result in undesired panning instructions.

However, alternative input methods may be used to move about the display screen such as to indicate the desired direction of panning.

It is thus advantageous to provide alternatives and to teach a user how to pan by way of these alternative input methods. One solution may provide a panning GUI and a user guide to present a “how to” manual in printed or electronic document format to show users how to pan using the device. Such a solution is separated from user operation of the GUI and requires a user to switch his or her attention between the guide and the GUI to learn its operations. Further, the user guide must be accessible when the user wants to learn to pan.

It is thus desirable to provide a GUI that pans effectively and shows a user how to pan. A solution that addresses one or more of these issues is therefore desired.

### BRIEF DESCRIPTION OF THE DRAWINGS

In order that the subject matter may be readily understood, embodiments are illustrated by way of examples in the accompanying drawings, in which:

FIGS. 1-3 illustrate views of a GUI for panning map images in accordance with an embodiment;

FIGS. 4 and 5A and 5B illustrate in detail a portion of the GUI of FIG. 1 in accordance with various embodiments;

FIGS. 6 and 7 illustrate embodiments of the GUI for panning map images on selected handheld communication devices having a track wheel and a track ball respectively;

FIG. 8 is a flow chart of selected GUI operations in accordance with an embodiment; and

FIG. 9 is a block diagram of a representative handheld communication device according to the prior art that may be configured with a GUI as described.

### DETAILED DESCRIPTION

Panning content on a computing device, particularly a handheld device, can be awkward using a device's incorporated track wheel or track ball especially when walking and operating the device. A graphical user interface that provides panning operations through key-based inputs and that teaches a user how to pan using the keys provides a solution. Importantly, panning cues may be provided contextually to a user, for example upon initiating a panning operation. Cues may be provided when the user is doing the task.

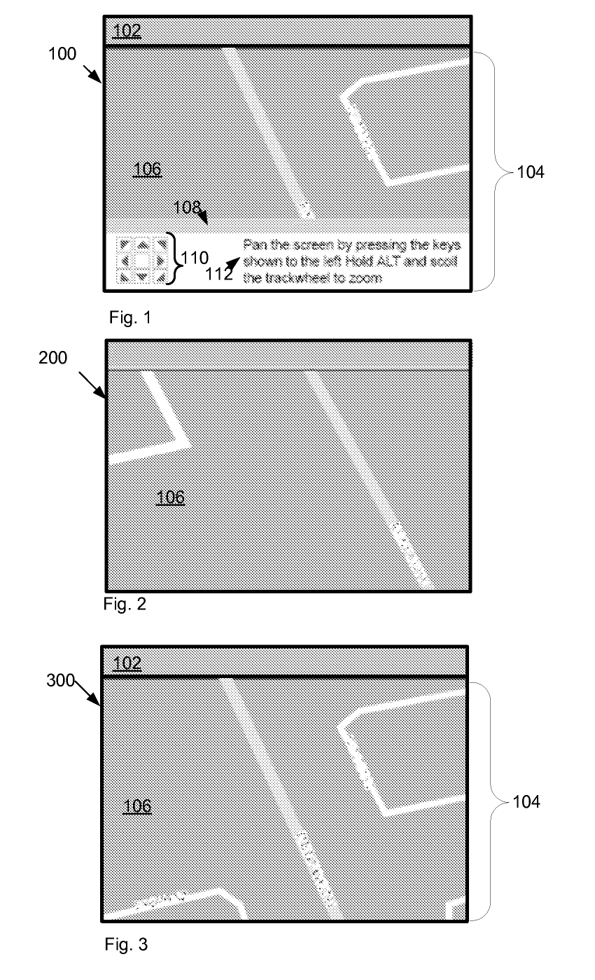

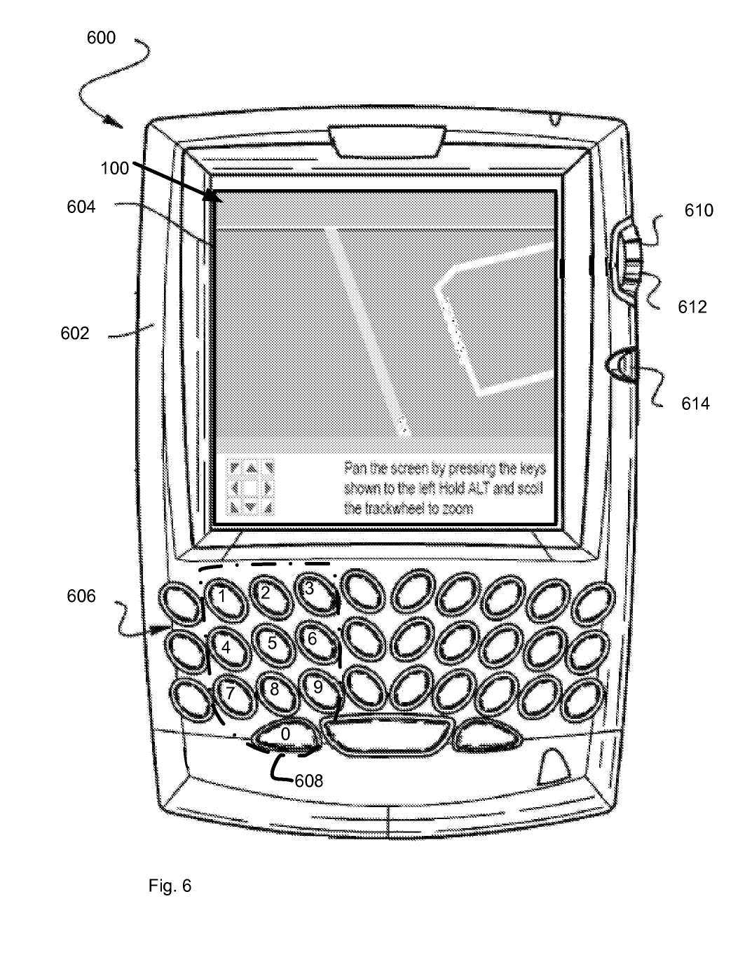

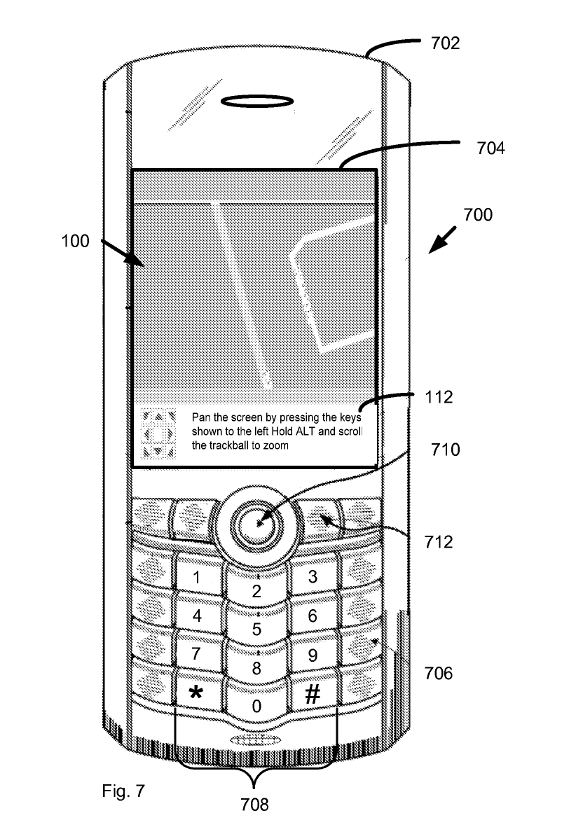

FIGS. 1-3 illustrate representative views (screen shots) of a graphical user interface (GUI) of a map viewing application of a computing device, particularly a handheld wireless communication device (hereinafter handheld device). Representative handheld devices 600 and 700 are illustrated in FIGS. 6 and 7. The GUI facilitates panning about the image(s) of the map in a plurality of directions. Advantageously, the GUI also illustrates how to pan using the keys to provide an effective yet easy to learn GUI.

Persons of ordinary skill in the art will appreciate that certain basic details related to standard operations of the map viewing application are omitted as they would be well understood to persons of ordinary skill. For example, selection and retrieval of the map images, communications for such operations and rendering or other displaying operations are not described.

View 100 of FIG. 1 shows an example view of a GUI for viewing maps that facilitates panning through operation of handheld device keys and that shows a user how to do so. View 100 comprises a top banner portion 102 such as for displaying the application name or map name (neither shown) and a main body portion 104 below the banner portion 102. Within body portion 104 are displayed the images of a map. A representative map image 106 is illustrated in view 100.

Persons of skill in the art will appreciate that a particular map may comprise multiple images to improve communication, storage and other performance factors. Different images may be used to construct adjacent portions of a map or to show more or less map detail (e.g. through zooming in or out). The area of a single image may be larger than the available display area of body portion 104 or images defining adjacent portions of the map may be available for display. Panning is a way to bring these off-screen images or image portions on-screen. It is noted that the images or visual representations can be 2D or 3D graphical representations or real life, real time photographs (e.g. satellite/aerial) or even video and combinations of same such as graphical representations overlaying photographs.

Handheld devices are often used by people on the move, whether when walking, driving or otherwise. Many handheld devices incorporate track wheel or track ball input devices for operating GUIs and navigating about the display screen. Movement of the user, especially when walking and using the handheld device, may translate through the user to his or her hands such that fine control of a track wheel or tack ball may not be as effective as when a user is not moving during operation of these input devices. When operating these types of input devices, unintentional GUI inputs may be occasioned which result in undesired panning instructions.

To address this effect, the GUI illustrated herein accepts inputs from keys of the handheld device for panning. In this way, control of panning may be enhanced as pressing keys is typically easier to control when a user is moving. An array of keys (preferably 8 peripheral keys of a 3×3 array) may be associated to respective panning direction inputs. Pressing one of the associated keys signals the GUI to pan the image in that direction by a predetermined amount. The image may be notionally divided into equal portions, preferably 9 in a 3×3 arrangement. All but the central portion maybe assigned a key for panning. Pressing one of the keys pans the portion associated with the one key to the centre of the display. For example, panning to the right moves the middle right portion of the image to the centre of the display, shifting the left top, left middle and left bottom portions off the display and the adjacent central portions to the left. Off screen portions of an image fills in the right side of the display body portion 104. Finer or coarser panning may be implemented. A user option may also be provided to set the panning parameter. View 200 of FIG. 2 shows image 106 after panning up to the left, in response to the pressing of the key associated with the top left portion of the image. Holding down one of the keys may be configured to continue to pan in the selected direction.

Advantageously, the GUI also shows a user how to pan using key inputs. Referring to FIG. 1, panning instructions 108 are displayed in body portion 104, preferably over a portion of the content (image 106). The instructions 108 may be displayed temporarily and removed to reveal all of the image 106. View 300 of FIG. 3 shows image 106 with the instructions 108 removed. Alternatively, though not shown, panning instructions 108 may fade out or slide off the screen for removal after a predetermined time (e.g. few seconds). If persistent, the instructions 108 may be transparent to permit viewing of content 106 there beneath.

The display of the panning instructions may be automatic. For example they may be displayed automatically when the map viewing application initially displays a map image. Preferably, they are displayed in response to user input such as by selecting a panning option from a GUI interface element (e.g. a menu (not shown)) for invocation. As is well-known, the GUI may provide a pop-up or other menu with one or more menu selections for operating the application. One option in the menu may be configured for panning. The selection of this option may be configured to invoke the display of the instructions 108. The selection may also enable or disable the panning feature (turn panning on or off) through the key inputs such that, when disabled, the GUI ignores panning key inputs.

Instructions 108 need not be shown every time panning is initiated. A user choice box or other setting may be provided to “Don't show me again” (not shown). In this way the showing of the instructions 108 may be enabled and disabled.

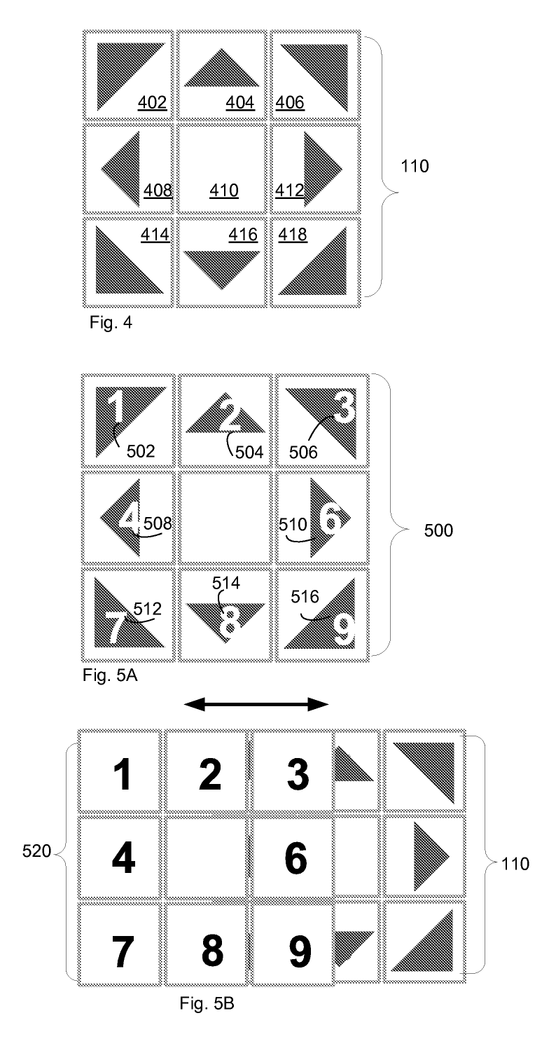

Importantly, the instructions 108 show and describe to a user how to pan using the panning keys (i.e. the array of keys associated with respective panning directions). The instructions 108 comprise a key map 110 and descriptive words 112. The key map 110 facilitates the illustration of the panning directions and the associated or mapped keys of the device that signal the directions. Further details of the key map are shown in FIGS. 4 and 5A and 5B. In this embodiment the descriptive words 112 describe both panning and zooming features. Zooming may be performed using a track wheel and key combination. In other embodiments where a track ball is available, zooming may use this input device and the description 112 amended accordingly. Though not necessary, the GUI may also be configured to pan using these input devices (track wheel or track ball, as available) in addition to key input devices.

With reference to FIGS. 4 and 5A and 5B, the key map 110 is shown in detail. In FIG. 4, the panning directions 401-418 are shown. As noted, pressing a key associated with a direction (e.g. 402) moves the images so that the corresponding portion of the image is in the centre (at position 410) of the display. Centre portion 410 need not be associated to a key.

Preferable, the keys associated for panning are the keys associated for telephone number input (e.g. telephone dialing, contact information input or other telephone number comprising) in a telephone-related GUI of an application on the handheld device, if available. However, other keys may be used. FIG. 5A illustrates a key map 500 displaying the dialing numbers associated to the panning directions. The instructions 108 preferably show the panning directions and indicate the panning keys associated with the directions. Static or dynamic (i.e. animated) user instructions 108 may be useful to show the association between the key array and the directions. User instructions 108 may alternate the display of key map 110 and 500 to show the association. The key labels 502-516 may blink on and off. An alternative is shown in FIG. 5B where an array of key labels 520 is shown moving on and off of key map 110 to illustrate the association.

FIGS. 6 and 7 show different embodiments of representative handheld devices displaying respective GUI embodiments of view 100 of FIG. 1. FIG. 6 shows a representative handheld device 600. Handheld device 600 comprises a body 602 having a display screen 604, on which is displayed view 100 of FIG. 1, a keyboard of keys 606, a track wheel 610 with click button 612 and a cancel button 614. Keys 606 included keys 608 labelled for telephone dialling. Key map 110 may be configured to show an association to the upper 3×3 array of these keys 608.

In an alternative embodiment, FIG. 7 shows a representative handheld device 700. Handheld device 700 comprises a body 702 having a display screen 704, on which is displayed view 100 of FIG. 1 (amended as described below), a keyboard of relatively fewer keys 706, a clickable track ball 710 and a cancel button 712. Keys 706 included keys 708 labelled for telephone dialling. Key map 110 may be configured to show an association to the upper 3×3 array of these keys 708. View 100 is amended at instructions 112 to reference the track ball 710 rather than the track wheel 610 of device 600.

Though not shown, the handheld devices 600 and 700 are configured (e.g. via software) to comprise various components including an operating system, a communications system for wireless communication, and applications such as a map viewing application for viewing map images as described with reference to FIGS. 1-4 and 5A-5B. Other viewing applications with panning features as described may include spreadsheet viewers, picture viewers, word processing document viewers, web browsers, etc.

Though the embodiments shown and described are with respect to map images, other content, whether image-based or not may be viewed and panned using a similar GUI in which the GUI illustrates how to pan using keys of the handheld device.

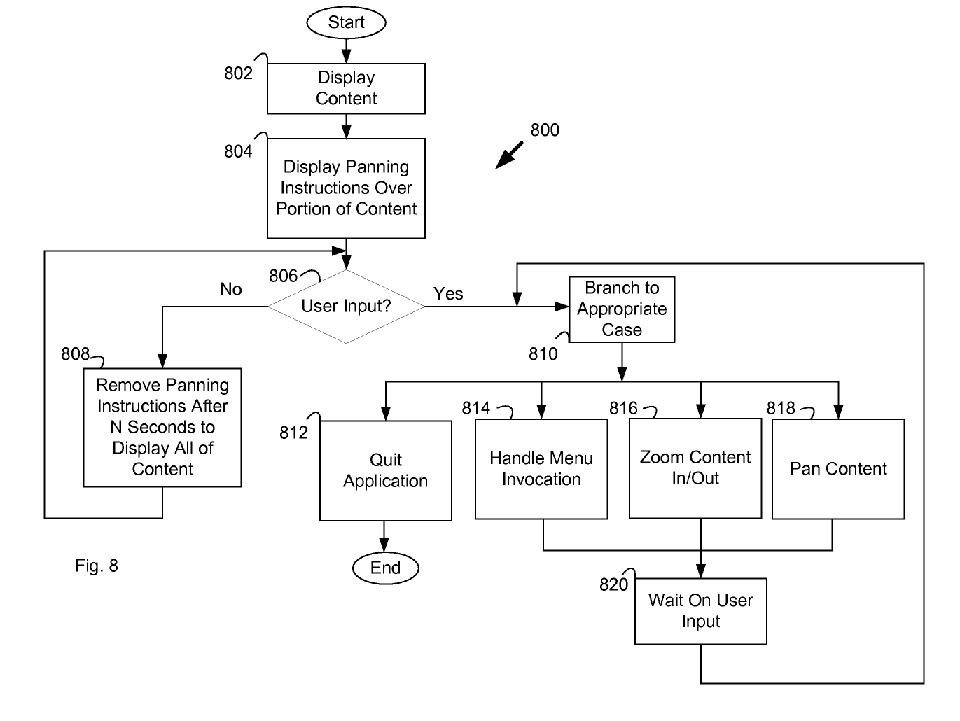

FIG. 8 illustrates simplified operations 800 for a GUI of a map viewing application. At step 802, content, namely an image such as 106, is displayed on the display screen. Automatically, or in response to user input such as invoking a menu and selecting panning (not shown), user instructions for panning are displayed over a portion of the content. As described above, the user instructions may be displayed temporarily. Should a user press a panning key or use another input device or should sufficient time elapse, the instructions may be removed.

Decision 806 determines if user input is occasioned. If not, operations may loop via step 808 until sufficient time has elapsed (e.g. a predetermined time of a few seconds) and the instructions are removed to display all of the content. If user input is determined, operations 810 and following handle the input accordingly. Only a few selected cases are illustrated though persons of ordinary skill will appreciate that many different user inputs could be received.

Operations at step 810 branch in response to the user input to various cases such as quitting the application (812), handling a menu invocation (814), zooming content in or out 816 and panning content (818). Some user inputs may stop operations 800. For example, a quit key input may be received 812. As well some menu options may provide quit or exit features (not illustrated). Should the operations 800 remain active following step 814 and following steps 816 and 818, at step 820 they wait for further input before looping back to step 810 to further process the input. Persons of ordinary skill in the art will appreciate that zooming content, panning and other GUI commands may be triggers to remove the display of the user instructions if same are on the display screen.

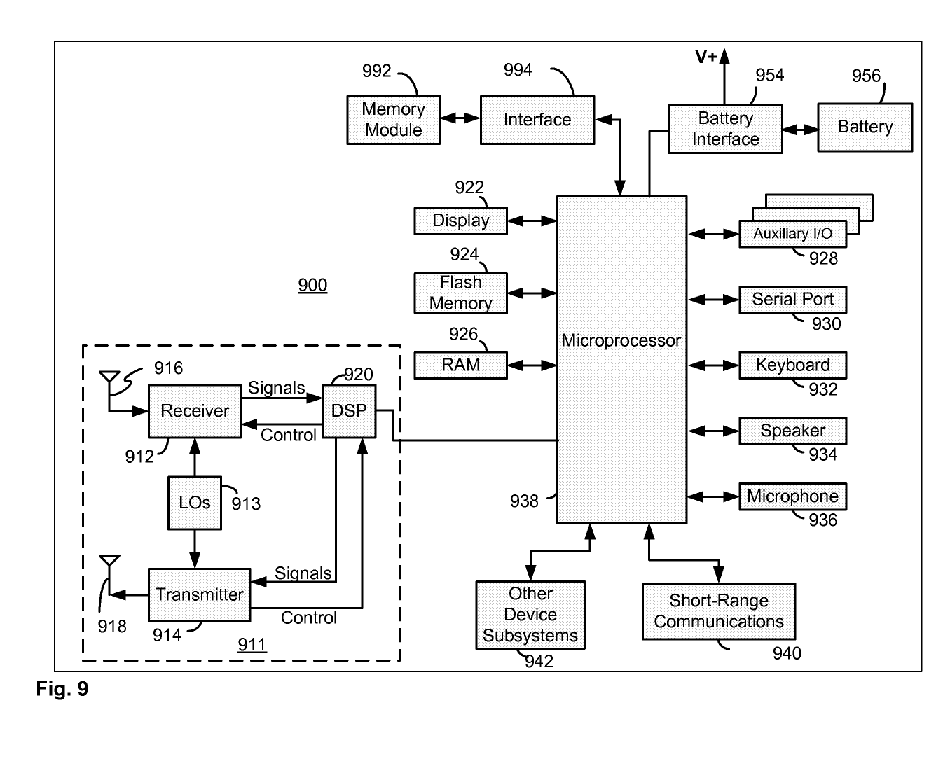

FIG. 9 is a detailed block diagram of an embodiment of a handheld wireless communication device 900 in accordance with the prior art that may be configured as either of devices 600 and 700 as described. Handheld device 900 is preferably a two-way communication device having at least voice and advanced data communication capabilities, including the capability to communicate with other computer systems. Depending on the functionality provided by handheld device 900, it may be referred to as a data messaging device, a two-way pager, a cellular telephone with data messaging capabilities, a wireless Internet appliance, or a data communication device (with or without telephony capabilities). Handheld device 900 may communicate with any one of a plurality of base station transceiver systems (not shown) within its geographic coverage area.

Handheld device 900 will normally incorporate a communication subsystem 911, which includes a receiver 912, a transmitter 914, and associated components, such as one or more (preferably embedded or internal) antenna elements 916 and 918, local oscillators (LOs) 913, and a processing module such as a digital signal processor (DSP) 920. As will be apparent to those skilled in field of communications, particular design of communication subsystem 911 depends on the communication network in which handheld device 900 is intended to operate.

Handheld device 900 may send and receive communication signals over the network after required network registration or activation procedures have been completed. Signals received by antenna 916 through the network are input to receiver 912, which may perform such common receiver functions as signal amplification, frequency down conversion, filtering, channel selection, and analog-to-digital (A/D) conversion. A/D conversion of a received signal allows more complex communication functions such as demodulation and decoding to be performed in DSP 920. In a similar manner, signals to be transmitted are processed, including modulation and encoding, for example, by DSP 920. These DSP-processed signals are input to transmitter 914 for digital-to-analog (D/A) conversion, frequency up conversion, filtering, amplification and transmission over communication network via antenna 918. DSP 920 not only processes communication signals, but also provides for receiver and transmitter control. For example, the gains applied to communication signals in receiver 912 and transmitter 914 may be adaptively controlled through automatic gain control algorithms implemented in DSP 920.

Network access is associated with a subscriber or user of handheld device 900, and therefore handheld device 900 comprises a memory module 992, memory module card or a Removable User Identity Module (R-UIM), to be inserted in or connected to an interface 994 in order to operate in the network. Alternatively, memory module 992 may be a non-volatile memory that is programmed with configuration data by a service provider so that mobile station 900 may operate in the network. Since handheld device 900 is a mobile battery-powered device, it also includes a battery interface 954 for receiving one or more rechargeable batteries 956. Such a battery 956 provides electrical power to most if not all electrical circuitry in handheld device 900, and battery interface 954 provides for a mechanical and electrical connection for it. The battery interface 954 is coupled to a regulator (not shown in FIG. 9) that provides power V+ to all of the circuitry.

Handheld device 900 includes a microprocessor 938 that controls overall operation of mobile station 900. Communication functions, including at least data and voice communications, are performed through communication subsystem 911. Microprocessor 938 also interacts with additional device subsystems such as a display 922, a flash memory 924, a random access memory (RAM) 926, auxiliary input/output (I/O) subsystems 928, a serial port 930, a keyboard 932, a speaker 934, a microphone 936, a short-range communications subsystem 940, and any other device subsystems generally designated at 942. Some of the subsystems shown in FIG. 9 perform communication-related functions, whereas other subsystems may provide “resident” or on-device functions. Notably, some subsystems, such as keyboard 932 and display 922, for example, may be used for both communication-related functions, such as entering a text message for transmission over a communication network, and device-resident functions such as a calculator or task list. Operating system software used by microprocessor 938 is preferably stored in a persistent store such as flash memory 924, which may alternatively be a read-only memory (ROM) or similar storage element (not shown). Those skilled in the art will appreciate that the operating system, specific device applications, or parts thereof, may be temporarily loaded into a volatile store such as RAM 926.

Microprocessor 938, in addition to its operating system functions, preferably enables execution of software applications on handheld device 900. A predetermined set of applications that control basic device operations, including at least data and voice communication applications, will normally be installed on handheld device 900 during its manufacture. A preferred application that may be loaded onto handheld device 900 may be a personal information manager (PIM) application having the ability to organize and manage data items relating to a user such as, but not limited to, e-mail, calendar events, voice mails, appointments, and task items. Naturally, one or more memory stores are available on handheld device 900 and memory module 992 to facilitate storage of PIM data items and other information. Device 900 may store a map application or other application (e.g. browser, spreadsheet, image or document viewing or processing application, etc.) comprising a GUI for panning as described herein.

The PIM application preferably has the ability to send and receive data items via the wireless network. In a preferred embodiment, PIM data items are seamlessly integrated, synchronized, and updated via the wireless network, with the mobile station user's corresponding data items stored and/or associated with a host computer system thereby creating a mirrored host computer on handheld device 900 with respect to such items. This is especially advantageous where the host computer system is the mobile station user's office or enterprise computer system. Additional applications may also be loaded onto handheld device 900 through network, an auxiliary I/O subsystem 928, serial port 930, short-range communications subsystem 940, or any other suitable subsystem 942, and installed by a user in RAM 926 or preferably a non-volatile store (not shown) for execution by microprocessor 938. Such flexibility in application installation increases the functionality of handheld device 900 and may provide enhanced on-device functions, communication-related functions, or both. For example, secure communication applications may enable electronic commerce functions and other such financial transactions to be performed using handheld device 900.

In a data communication mode, a received signal such as a text message, an e-mail message, or web page download will be processed by communication subsystem 911 and input to microprocessor 938. Microprocessor 938 will preferably further process the signal for output to display 922 or alternatively to auxiliary I/O device 928. A user of handheld device 900 may also compose data items, such as e-mail messages, for example, using keyboard 932 in conjunction with display 922 and possibly auxiliary I/O device 928. Keyboard 932 is preferably a complete alphanumeric keyboard and/or telephone-type keypad. These composed items may be transmitted over a communication network through communication subsystem 911.

For voice communications, the overall operation of handheld device 900 is substantially similar, except that the received signals would be output to speaker 934 and signals for transmission would be generated by microphone 936. Alternative voice or audio I/O subsystems, such as a voice message recording subsystem, may also be implemented. Although voice or audio signal output is preferably accomplished primarily through speaker 934, display 922 may also be used to provide an indication of the identity of a calling party, duration of a voice call, or other voice call related information, as some examples.

Serial port 930 in FIG. 9 is normally implemented in a personal digital assistant (PDA)-type communication device for which synchronization with a user's desktop computer as a desirable, albeit optional, component. Serial port 930 enables a user to set preferences through an external device or software application and extends the capabilities of handheld device 900 by providing for information or software downloads to handheld device 900 other than through a wireless communication network. The alternate download path may, for example, be used to load an encryption key onto handheld device 900 through a direct and thus reliable and trusted connection to thereby provide secure device communication.

Short-range communications subsystem 940 is an additional optional component that provides for communication between handheld device 900 and different systems or devices, which need not necessarily be similar devices. For example, subsystem 940 may include an infrared device and associated circuits and components, or a Bluetooth™ communication module to provide for communication with similarly enabled systems and devices. Bluetooth™ is a registered trademark of Bluetooth SIG, Inc.

Although specific embodiments of the invention have been described herein, it will be understood by those skilled in the art that variations may be made thereto without departing from the spirit of the invention or the scope of the appended claims.

What is claimed is:

1. A method of panning content in a graphical user interface (GUI) for viewing the content on a display screen of a computing device comprising:
displaying the content on the display screen;
associating a plurality of keys of the computing device to a plurality of respective panning directions for receiving user input via the keys to pan the content; and
displaying user instructions showing a user how to pan using the keys.

2. The method of claim 1 comprising providing a user interface element for a user to initiate panning of the content and wherein the step of displaying user instructions is performed in response to an initiation of panning.

3. The method of claim 1 wherein the user instructions comprise a key map illustrating the association of the keys to the respective panning directions.

4. The method of claim 3 wherein the display of the key map is animated to illustrate the association between the keys and the panning directions.

5. The method of claim 3 wherein the keys are also associated for telephone number input in a telephone GUI for the computing device.

6. The method of claim 1 wherein said step of associating associates the plurality of keys to a like plurality of portions of the content located about a central portion of the content and wherein a user input using a one of the keys pans the respective associated portion of the content to the centre of the display screen.

7. The method of claim 1 comprising removing the user instructions in response to at least one of user input and elapsed time to temporarily display the user instructions.

8. The method of claim 1 wherein the instructions further show a user how to zoom the content.

9. The method of claim 1 wherein the content is at least one image defining a map and the computing device comprises a handheld communication device.

10. A handheld device having a display screen and a plurality of keys for receiving user input, said handheld device comprising:
an application for viewing content, said application having a graphical user interface (GUI) configured for:
displaying the content on the display screen;
associating a plurality of keys of the handheld device to a plurality of respective panning directions for receiving user input via the keys to pan the content; and
displaying user instructions showing a user how to pan using the keys.

11. The handheld device of claim 10 wherein the user instructions comprise a key map illustrating the association of the keys to the respective panning directions.

12. The handheld device of claim 11 wherein the keys are also associated for telephone number input in a telephone GUI for the computing device.

13. The handheld device of claim 11 wherein the display of the key map is animated to illustrate the association of the keys to the panning directions.

14. The handheld device of claim 10 wherein said GUI associates the plurality of keys to a like plurality of portions of the content located about a central portion of the content and wherein a user input using a one of the keys pans the respective portion of the content associated with the one of the keys to the centre of the display screen.

15. The handheld device of claim 10 wherein said GUI is configured to remove the user instructions in response to one or more of user input and elapsed time to temporarily display the user instructions.

16. The handheld device of claim 10 wherein said GUI is configured to provide a menu for invoking panning and wherein said GUI displays the user instructions in response to an invocation of panning via the menu.

17. The handheld device of claim 10 wherein the user instructions further show a user how to zoom the content.

18. The handheld device of claim 10 wherein the content is at least one image defining a map.

19. A computer program product having computer readable code embodied therein, for execution by a processor for configuring a computing device to view content in a graphical user interface on a display screen, said computer program product comprising instructions and data for configuring a processor of the computing device to perform the method of claim 1.
